(19) United States
(12) Patent Application Publication
(10) Pub. No.: US 2012/0024024 A1
(43) Pub. Date: Feb. 2, 2012

(54) ELECTRONIC COMBINATION LOCK

(75) Inventors: Bernhard Faber, Leipzig (DE); Thomas Rothenbacher, Stuttgart (DE)

(73) Assignee: FREE AKTIENGESELLSCHAFT, Stuttgart (DE)

(21) Appl. No.: 13/258,489

(22) PCT Filed: Mar. 24, 2009
(86) PCT No.: PCT/EP09/53455

§ 371 Date: Sep. 22, 2011

(51) Int. Cl. E05B 49/00; E05B 37/00

(52) U.S. Cl. 70/278.1; 70/320

(57) ABSTRACT

The present invention relates to a lock (10). Particularly, the invention relates to an electronic combination lock suitable for industrial, commercial or residential use. More particularly, the present invention relates to an electronic combination lock, in which a person may input a code and the lock unlocks, if the input code equals a code stored in the lock. The lock comprises a input device (16) for inputting a code, a control unit (22) with a set of codes, one of the codes of the set of codes being set as an actual code and one of the codes of the set of codes being a subsequent code of the actual code and a lock mechanism for unlocking and locking the lock, wherein the control unit (22) causes the lock mechanism (14) to unlock, if the actual code is input to the input device (16), and the control unit (22) sets the subsequent code as the actual code, if the subsequent code is input to the input device (16).

### FIELD OF THE INVENTION

The present invention relates to a lock. Particularly, the invention relates to an electronic combination lock suitable for industrial, commercial or residential use. More particularly, the present invention relates to an electronic combination lock, in which a person may input a code and the lock unlocks, if the input code equals a code stored in the lock.

### BACKGROUND OF THE INVENTION

Keyless electronic combination locks are well-known in the prior art. They are used in locker rooms, e.g. for securing luggage in stations or airports or for securing doors of buildings. These locks are very useful if the users which are authorized to open the locks frequently change. If the authorization to open one or more of the locks has to be transferred from an old user to a new user, no problem arises with a key that has to be delivered form the old user to the new user. Simply, the code for opening the lock can be changed. Then, an old user not knowing the new code is not anymore able to open the lock. Further, no assurance has to be made, if the old user has copied the key.

Frequently, a number of these locks are part of a central locking system. For changing the code of one of the electronic combination locks, a reprogramming of the lock may be done by an online connection to the central locking system. Alternatively, the programming locally may be changed by a maintenance technician.

### SUMMARY OF THE INVENTION

It may be a problem, that the locks maintained by the central locking system are far separated from each other. This is, for example, the case for locks used for locking doors in a large building. In this case, long lines have to be laid or some other kind of communication between the locks and the central locking system, such as a radio communication network, has to be established. Further, it may be a problem, that the local maintenance by a technician is very time-consuming and costly.

It is an object of the invention to provide a lock, that can be simply installed and that needs little maintenance.

According to an exemplary embodiment of the invention, a lock is provided, comprising: an input device for inputting a code; a control unit with a set of codes, one of the codes of the set of codes being set as an actual code and one of the codes of the set of codes being a subsequent code of the actual code, and a lock mechanism for unlocking and locking the lock; wherein the control unit causes the lock mechanism to unlock, if the actual code is input to the input device and the control unit sets the subsequent code as the actual code, if the subsequent code is input to the input device.

With the set of codes, a number of codes is programmed into or stored in the lock. One of the codes is set or marked as the actual code. If a user enters the actual code into the lock by inputting it into the input device, the lock unlocks or opens. One or more of the codes stored in the lock are marked as being subsequent codes to another code stored in the lock. If the authorization to open the lock has to be transferred from an old user to a new user, the new user is told one of the subsequent codes. When the new user inputs or enters the subsequent code into the lock, the subsequent code becomes the actual code. Now, the new user can open the lock with the subsequent code, which has become the actual code. The old user is not anymore able to open the lock, since the code known to him is not any longer the actual code.

The number of codes in the set of codes may be limited by the available memory of the control unit. For safety reasons, a set of codes may comprise at least about 100 codes.

A code may be a sequence of symbols, such as several digits or letters or pictures. A code may also be a combination of lines that is drawn on e.g. a touchpad, which may be a possible input device.

An input device may also be a keypad for entering digits or letters. A possible input device can also be a rotary knob, by means of which the symbols of a code may be input by certain rotations or rotary positions of the knob.

The lock mechanism may comprise a bar which is movable if the lock is unlocked and which is not movable if the lock is locked. Alternatively or additionally, the lock mechanism may be an electromagnetic lock mechanism, a hydraulic lock mechanism or a vacuum lock mechanism.

The control unit may be a processor and the set of codes may be stored in the memory of the processor.

According to an exemplary embodiment, the control unit causes the lock mechanism to unlock, if the subsequent code is input to the input device. In this case, the new user only has to input the subsequent code once to activate the lock for the new actual code and to open it.

According to an exemplary embodiment, the set of codes is a list and the subsequent code of a code of the list is the next code in the list. With this, no complicated data structure has to be programmed into or stored in the control unit.

According to an exemplary embodiment, the list starts with a first code and ends with a last code and the subsequent code of the last code is the first code. Preferably, the first actual code of the lock is the first code in the list. If all codes of the list have been used, the first code of the list becomes again the actual code for opening the lock. No maintenance is needed, even if all codes stored in the lock are used up.

According to an exemplary embodiment, it is possible that two or more codes of the set of codes are subsequent codes of a code. In this case, two new users may be provided with two different codes and the first of the two users who authorizes himself for opening the lock becomes the only user who is able to open the lock. The other of the two users can not any more authorize himself for opening the lock, if the subsequent codes of the new actual code are not the subsequent codes of the old actual code. This may be useful, if the lock is part of a locking system comprising a plurality of locks, like a locker room. The users can then choose their lockers themselves among a number of lockers.

According to an exemplary embodiment, the control unit may set the subsequent code as the actual code, if the actual code is input to the input device. This may be beneficial in the case of a lock of a shop box. A mailman is provided with the actual code and can open the shop box to put a parcel into it. After he has closed the shop box he is not able to open the shop box again. An owner of the shop box may open the shop box with a master code or with the subsequent code.

According to an exemplary embodiment, at least two of the codes of the set of codes are set as actual codes, wherein the control unit causes the lock mechanism to unlock, if one of the actual codes is input to the input device. According to a further exemplary embodiment, the control unit sets the subsequent codes of the actual codes as the actual codes, if one of the subsequent codes is input to the input device. Every actual code may have a different subsequent code. It may also be possible, that some or all of the actual codes have one subsequent code. For example, this may be beneficial in a hotel, where a plurality of users have access to their hotel rooms with individual different actual codes and have access to a conference room which can be opened with each of the actual codes.

According to an exemplary embodiment, it is possible that a code of the set of codes does not have a subsequent code. This code may be the last code in a list of codes. After every code in the list of codes has been used, it is not possible any more to change the actual code. A new list of codes has to be programmed into or stored in the lock. With this, it becomes possible to ensure that the same code will not be used twice for the same lock.

Another aspect of the invention is a method for unlocking a lock having a set of codes, one of the codes of the set of codes being set as an actual code and one of the codes being a subsequent code of the actual code, the method comprising the steps of: inputting an input code; unlocking the lock, if the input code is the actual code; setting the subsequent code as the actual code, if the input code is the subsequent code.

A further aspect of the invention is a computer-readable medium, in which a computer program for unlocking a lock is stored, which, when being executed by a processor, is adapted to carry out this method.

A computer-readable medium may be a floppy disk, a hard-disk, an USB (Universal Serial Bus) storage device, a RAM (Read Access Memory), a ROM (Read Only Memory) and an EPROM (Erasable Programming Read Only Memory). A computer-readable medium may also be a data communication network, e.g. the internet, which allows downloading a program code.

Another aspect of the invention is a program element for unlocking a lock, which, when being executed by a processor, is adapted to carry out this method.

These and other aspects of the invention will be apparent from and elucidated with reference to the embodiments described hereinafter.

### BRIEF DESCRIPTION OF THE DRAWINGS

Below, embodiments of the present invention are described in more detail with reference to the attached drawings. It shows:

FIG. 1 shows a functional diagram of a lock.

FIG. 2 shows an embodiment of a set of codes.

FIG. 3 shows a further embodiment of a set of codes.

FIG. 4 shows a flow diagram for the operation of the lock of FIG. 1.

### DETAILED DESCRIPTION OF EMBODIMENTS

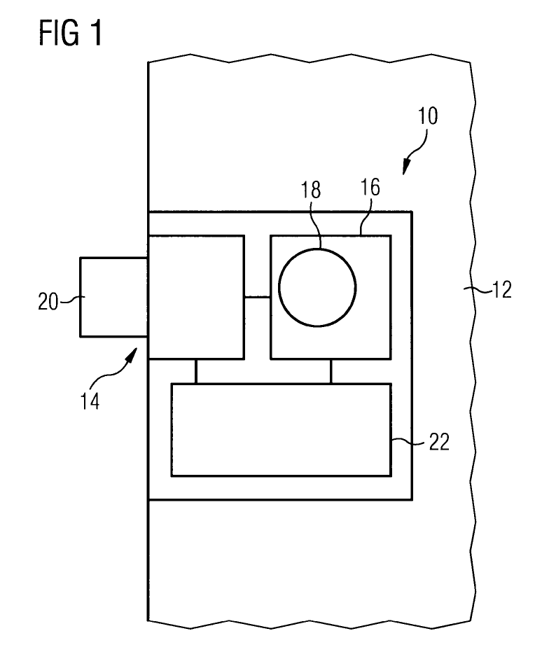

FIG. 1 shows an embodiment of an electronic combination lock 10 being installed in a door 12. The lock may be part of a locking system, such as a locker room and the door may be the door of one of the lockers. The lock 10 comprises a lock mechanism 14, an input device 16 and a control unit 22. The input device 16 comprises a rotary knob 18 which is mounted on the outside of the door 12 and protrudes therefrom. The rotary knob 18 has a mark which can be pointed to digits 0 to 9 placed around the rotary knob 18 on the door 12 by rotating the rotary knob 18 to input one of the digits 0 to 9.

The lock mechanism 14 comprises a bar 20 which is movable when the lock 10 is opened or unlocked and which is engaging into a frame of the door 12 for preventing to open the door 12, if the lock 10 is locked. If the bar 20 is movable the rotary knob 18 may also be used to mechanical move the bar 20 for opening the lock 10.

The control unit 22 comprises an electronic chip with a processor and a memory. In the memory a set of 100 codes is stored. It is also possible, that one or more master codes are stored in the control unit 22. With a master code the lock 10 always can be unlocked. Preferably, a master code is identical for all locks 10 of the same locking system.

One of the codes of the set of codes in the memory of the control unit 22 is marked or set as an actual code. If the actual code is input or entered into the input device 16, the lock 10 unlocks.

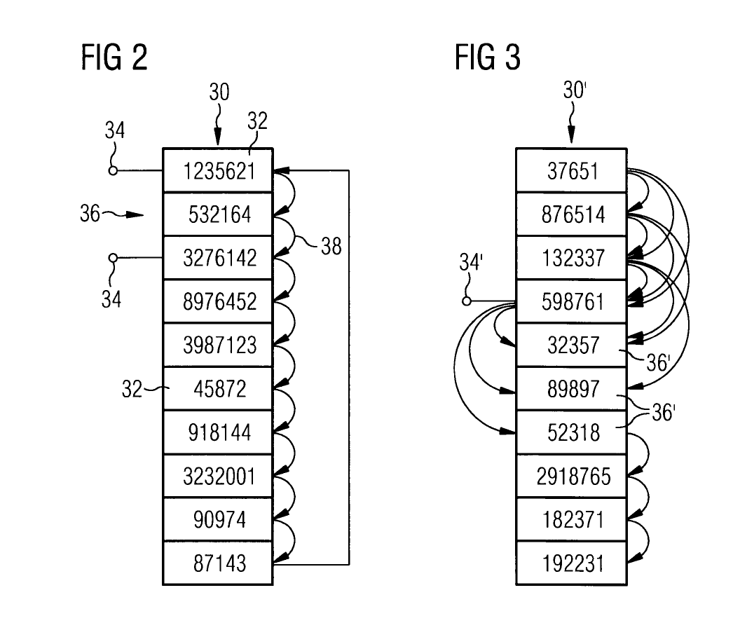

FIG. 2 shows an exemplary embodiment of a set of codes 30 that may be stored in the control unit 22. The set of codes 30 is a list of ten codes 32 with the first code “1235621” being marked as actual code 34. The third code “3276142” is marked as actual code 34, too. As characterized by the predecessor—successor-relationship 38 the second code “532164” is the subsequent code of the actual code 34. Similarly, the code “326142” is the subsequent code of the second code “532164”. In the simplest case, the set of codes 30 is a list and the subsequent code of a code is the next code in the list. It is possible, that the set of codes 30 forms a ring via the predecessor-successor-relationships 38 of the codes 32. As can be seen from FIG. 2, the last code “87143” has a subsequent code which is the first code in the list.

FIG. 3 shows another embodiment of a set of codes 30′ containing ten different codes. The actual code 34′ has three subsequent codes 36′. A set of codes similar to that shown in FIG. 3 may be implemented by a list wherein the three subsequent codes of a code are the three next codes in the list. Also more than three, e.g. five codes or only two codes may be the subsequent codes of a code. The last code “192231” of the set of codes 30 has no subsequent code.

The lock 10 may be reprogrammable. It may be possible that a maintenance technician can alter the set of codes stored in the lock or can store a new set of codes into the lock. This may be done locally via the input device 16, by an electronic interface of the lock or via a communication line to a central locking system.

The set of codes stored in one lock or all the codes stored in the locks of a locking system may also be stored in a database of the operator of the locking system. In the database, the actual code for every lock and the predecessor-successor-relationships may be stored, too. Always when a new user has to be authorized for a lock, the operator of the locking system can request a subsequent code for the respective lock from the database. In a simpler embodiment, no database is needed, but the codes are listed in a table.

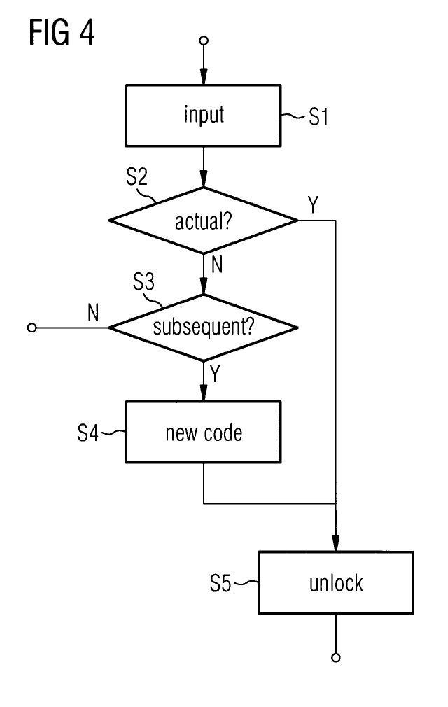

FIG. 4 shows a flow diagram of a program runable on the processor of the control unit 22.

In step S1 the control unit 22 is waiting for an input from the input device 16. To input a digit of the code a user has to rotate the rotary knob 18 to the respective digit 0 to 9 placed on the door and to hold the rotary knob in this position for a certain time, e.g. a second. After that, the rotary knob may be rotated to the next digit of the code. The length of the code may be set to a specific number of digits. The control unit 22 may identify the completion of the input of a code, when a certain number of digits has been reached or when no further digit has been input for a certain time.

In step S2, the control unit 22 compares, if the code input with the input device 16 equals the code or one of the codes being set as actual code. If this is the case, the control unit 22 goes on to step S5 and causes the lock mechanism 14 to unlock the lock. Additionally, in step 55 the control unit 22 may set a subsequent code as the actual code.

If the input code is not an actual code, the control unit 22 compares the input code with the subsequent codes of the actual code or the actual codes. If this is not the case, the program stops and restarts again at step S1. If the input code equals a subsequent code the control unit 22, in step S4, sets the subsequent code as the new actual code and goes on to step S5 to unlock the lock. In the case of a plurality of actual codes, the control unit 22 sets the subsequent codes of the actual codes as the new actual codes.

After step S5 the program stops and restarts at step S1.

While the invention has been illustrated and described in detail in the drawings and foregoing description, such illustration and description are to be considered illustrative or exemplary and not restrictive; the invention is not limited to the disclosed embodiment. Other variations to the disclosed embodiment can be understood and effected by those skilled in the art and practising the claimed invention, from a study of the drawings, the disclosure, and the appended claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

1. A lock (10) comprising:
a input device (16) for inputting a code;
a control unit (22) with a set of codes (30, 30′), one of the codes of the set of codes being set as an actual code (34, 34′) and one of the codes of the set of codes being a subsequent code (36, 36′) of the actual code (34, 34′); and
a lock mechanism (14) for unlocking and locking the lock (10);
wherein the control unit (22) causes the lock mechanism (14) to unlock, if the actual code (34, 34′) is input to the input device (16), and
the control unit (22) sets the subsequent code (36, 36′) as the actual code (34, 34′), if the subsequent code (36, 36′) is input to the input device (16).

2. The lock of claim 1, wherein the control unit (22) causes the lock mechanism (22) to unlock, if the subsequent code (36, 36′) is input to the input device.

3. The lock of claim 1 or 2, wherein the set of codes is a list (30) and the subsequent code of a code (32) of the list (30) is the next code (36) in the list.

4. The lock of claim 3, wherein the list (30) starts with a first code and ends with a last code and wherein the subsequent code of the last code is the first code.

5. The lock of one of the preceding claims, wherein the control unit (22) sets the subsequent code (36, 36′) as the actual code (34, 34′), if the actual code (34, 34′) is input to the input device (16).

6. The lock of one of the preceding claims, wherein at least two of the codes of the set of codes are set as actual codes,
wherein the control unit (22) causes the lock mechanism (14) to unlock, if one of the actual codes is input to the input device (16), and
wherein the control unit (22) sets the subsequent codes of the actual codes as the actual codes, if one of the subsequent codes is input to the input device (16).

7. The lock of one of the preceding claims, wherein a code of the set of codes (30′) does not have a subsequent code.

8. A method for unlocking a lock (10) having a set of codes (30, 30′), one of the codes of the set of codes being set as an actual code (34, 34′) and one of the codes being a subsequent code (36, 36′) of the actual code (34, 34′), the method comprising the steps of:
inputting an input code;
unlocking the lock (10), if the input code is the actual code (34, 34′);
setting the subsequent code (36, 36′) as the actual code (34, 34′), if the input code is the subsequent code (36, 36′).

9. The method of claim 8, comprising the step of:
unlocking the lock, if the input code is the subsequent code (36, 36′).

10. The method of claim 8 or 9, wherein the set of codes is a list (30) and the subsequent code (36) of a code (32) of the list is the next code in the list.

11. The method of claim 10, wherein the list (30) starts with a first code and ends with a last code and wherein the subsequent code (36) of the last code is the first code.

12. The method of one of the claims 8 to 11, comprising the step of:
setting the subsequent code as the actual code, if the input code is the actual code.

13. The method of one of the claims 8 to 12, wherein at least two of the codes of the set of codes are set as actual codes, comprising the steps of:
unlocking the lock, if the input code is one of the actual codes, and
setting the subsequent codes of the actual codes as the actual codes, if the input code is one of the subsequent codes.

14. The method of one of the claims 8 to 13, wherein a code of the set of codes (30′) does not have a subsequent code.

15. A computer-readable medium, in which a computer program for unlocking a lock is stored, which, when being executed by a processor, is adapted to carry out one of the methods of claims 8 to 14.

16. A program element for unlocking a lock, which, when being executed by a processor, is adapted to carry out one of the methods of claims 8 to 14.
